(19) United States
(12) Patent Application Publication
(10) Pub. No.: US 2026/0092703 A1
(43) Pub. Date: Apr. 2, 2026

(54) COMBUSTION FURNACE AND ASSEMBLY

(71) Applicant: L'Air Liquide, Société Anonyme pour l'Etude et l'Exploitation des Procédés Georges Claude, Paris (FR)

(72) Inventors: Chaimae BARIKI, Jouy-en-Josas (FR); Remi TSIAVA, Saint Germain-les-Corbeil (FR)

(21) Appl. No.: 19/334,088

(22) Filed: Sep. 19, 2025

(30) Foreign Application Priority Data
Sep. 30, 2024 (FR) 2410484

(51) Int. Cl. F23D 14/84; F23D 14/22; F23D 23/00; F27D 99/00

(52) U.S. Cl. CPC F23D 14/84; F23D 14/22; F23D 23/00; F27D 99/0033; F23D 2205/00

(57) ABSTRACT

A combustion assembly and furnace having at least one such combustion assembly, the combustion assembly including a non-metallic refractory block extending over a height h between a lower end and an upper end, having an inlet face and an outlet face opposite the inlet face, the block) being divided over its height h into several levels, each level containing at least one passage for injecting fuel and/or oxidizer, each passage extending from the inlet face to the outlet face and terminating in at least one injection aperture in the outlet face of the block, the at least one injection aperture of each level defining, on the outlet face, a contact rectangle, two segments of which are parallel to the direction of the height h and two segments of which are perpendicular to the direction of the height h, the assembly also including burners

[symbol]

### CROSS REFERENCE TO RELATED APPLICATIONS

This application claims the benefit of priority under 35 U.S.C. § 119 (a) and (b) to French Patent Application No. FR2410484, filed Sep. 30, 2024, the entire contents of which are incorporated herein by reference.

### BACKGROUND

The present invention relates to a combustion assembly and a furnace equipped with at least one such combustion assembly.

In industrial thermal processes, it is known to heat a charge in a furnace using one or more flames generated by the combustion of a fuel with an oxidizer.

The intensity, orientation, length and cross section of the one or more flames are generally adapted to the charge and to the position of the charge with respect to the burners generating the flames.

For example, the orientation and length of a flame may be chosen so as to impact the charge in order to improve the heat transfer to the charge. When the charge has a large surface area oriented towards the burner, the width and the height of the flame may be chosen so that the charge is heated over the whole of this surface area.

However, optimizing certain industrial thermal processes requires greater flexibility, for example when the distance between the charge and the burner and/or the height of the charge vary over time when the furnace is in operation.

It is known from U.S. Ser. No. 11/598,522, in a “batch type” tilt rotary melting furnace, to operate a first burner producing a first flame at a first power and to operate a second burner, which produces a second flame and is mounted above the first burner, at a second power. The known melting process comprises two phases. In a first phase, the solid charge in the furnace obstructs the first flame. During this phase, the second power is greater than the first power. In a subsequent phase, the charge has melted enough so as to no longer obstruct the development of the first flame. The two burners are then adjusted so that the first power, i.e. the power of the first flame that is closest to the charge, is greater than the second power, i.e. the power of the second flame.

This process improves melting efficiency in a “batch style” tilt rotary melting furnace, to which it is restricted. Furthermore, it provides limited adaptability with respect to the charge.

The present invention is therefore intended to at least partly overcome the drawbacks in the known processes.

### SUMMARY

The aim of the present invention more particularly includes providing a combustion assembly for reliably providing combustion that is adaptable/flexible or more adaptable/flexible, as well as an adaptable/flexible furnace provided with at least one such combustion assembly.

To this end, the present invention proposes a combustion assembly including a non-metallic refractory block and several burners.

The refractory block extends over a height h between a lower end (or bottom) and an upper end (or top).

The block has an inlet face and an outlet face opposite the inlet face. The outlet face and the inlet face are spaced apart by a thickness ep, referred to as the thickness of the block.

When the block is installed in a furnace, the outlet face is oriented towards the combustion zone and therefore constitutes the “hot” face of the block, whereas the “cold” inlet face is located outside this combustion zone.

Over its height h, the block is divided into several levels or stages.

Each level contains at least one passage, i.e. one or more passages, for injecting fuel and/or oxidizer (combustion oxidant). Each passage extends from the inlet face to the outlet face and terminates in at least one injection aperture in the outlet face of the block.

As each level contains at least one passage, each level has at least one injection aperture in the outlet face of the block.

The at least one injection aperture of each level defines a contact rectangle (also known as “intouch rectangle”) on the outlet face. Two segments or sides of the contact rectangle are parallel to the direction of the height h. The other two segments or sides are perpendicular to the direction of the height h. Each injection aperture of the corresponding level is located entirely inside said contact rectangle and each segment or side of the contact rectangle is in contact with the contour of at least one of the at least one injection aperture of the corresponding level.

The combustion assembly includes a plurality of burners with one burner per level. The number of levels is therefore equal to the number of burners.

In the present context, burner is understood to mean a device for injecting and bringing into contact a fuel and an oxidizer, supplied respectively by a source of fuel and by a source of oxidizer, for the combustion of said injected fuel with said injected oxidizer in a single flame downstream of the burner.

Each burner of the combustion assembly according to the present invention has injectors, including:
at least one injector for injecting a fuel and
at least one injector for injecting an oxidizer.

The at least one injector for injecting a fuel of each burner is fluidically connected to a fuel inlet of the burner and the at least one injector for injecting an oxidizer of each burner is fluidically connected to an oxidizer inlet of the burner.

Each burner is mounted on the corresponding level of the block such that the fuel and oxidizer injectors of said burner are inserted into the at least one passage of the corresponding level, such that the fuel and oxidizer inlets of the burner are located on the inlet face of the block.

Each burner is able to generate a flame by combustion of the fuel with the oxidizer downstream of the outlet face of the block. According to the present invention, each burner is able to generate such a flame, the length of which may be varied with identical fuel and oxidizer and with constant flame power. In other words, each burner is able to vary the length of the flame generated without modifying the supply of fluids to the burners.

Also according to the invention, the at least one injection passage of the various levels are oriented and spaced apart such that when the burners generate a flame downstream of the outlet face of the block by combustion of the fuel with the oxidizer, the flames generated by the various burners are spaced apart from one another and non-convergent.

With regard to the level contiguous with the lower end of the block, the contact rectangle defined on the outlet face in the level contiguous with the lower end of the block has segments perpendicular to the direction of the height h, the length x of which is at least twice the length y of the segments parallel to the direction of the height h.

For the operation of the combustion assembly, the fuel inlets are connected to a source of fuel, for example a fuel tank or pipeline, and the oxidizer inlets are connected to a source of oxidizer, for example an air blower, an air/gas separation unit, or an oxygen tank or pipeline.

The block may be a rectangular parallelepiped, also referred to as a “rectangular cuboid”. In each level of the block, the at least one passage for injecting fuel and/or oxidizer determines the direction of the flame generated in the combustion zone downstream of the outlet face of the block by the burner corresponding to said level.

According to the invention, the contact rectangle defined on the outlet face in the level contiguous with the lower end of the block has segments perpendicular to the direction of the height h, the length x of which is at least twice the length y of the segments parallel to the direction of the height h. However, one or more other levels may also have such a contact rectangle. According to one embodiment, the contact rectangles of all of the levels have segments perpendicular to the direction of the height h, the length x of which is at least twice the length y of the segments parallel to the direction of the height h.

Such a contact rectangle defined on the outlet face of the level contiguous with the lower end of the block having segments perpendicular to the direction of the height h, the length x of which is at least twice the length y of the segments parallel to the direction of the height h, notably enables the corresponding burner to produce a flame, the cross section of which has a dimension in the direction perpendicular to the direction of the height h that is greater than its dimension in the direction of the height h.

According to one particular embodiment, the assembly has only two levels and therefore has only two burners. In this case, one of the two levels is contiguous with the lower end of the block and the other of the two levels is contiguous with the upper end of the block. According to another useful embodiment, the assembly has exactly three levels and therefore includes three burners. In this case, one of the three levels is contiguous with the lower end of the block, another of the three levels is contiguous with the upper end of the block, and the third level is located between the two aforementioned levels.

As indicated above, the at least one injection passage of the various levels are oriented and spaced apart such that when the burners of the various levels generate a flame downstream of the outlet face of the block by combustion of the fuel with the oxidizer, the flames generated by the various burners are non-convergent with respect to each other. According to one embodiment, the at least one injection passage of the various levels are oriented and spaced apart such that when the burners of the various levels generate a flame by combustion of the fuel with the oxidizer, at least two of the flames generated by the various burners are parallel. According to another embodiment, the at least one injection passage of the various levels are oriented and spaced apart such that when the burners of the various levels generate a flame by combustion of the fuel with the oxidizer, at least two of the flames generated by the various burners are divergent. The two embodiments described above may also be combined in one and the same combustion assembly including at least three levels. In this case, the at least one injection passage of the various levels are oriented and spaced apart such that when the burners of the various levels generate a flame by combustion of the fuel with the oxidizer, at least two of the flames generated by the various burners are parallel and at least two of the flames generated by the various burners are divergent.

According to certain embodiments, all of the flames generated by the various burners are parallel to each other, or all of the flames generated by the various burners are divergent with respect to each other.

According to one advantageous embodiment, the at least one injection passage of the various levels are positioned such that when the burners of the various levels generate a flame downstream of the outlet face of the block by combustion of the fuel with the oxidizer, the flames generated by the various burners are aligned. Thus, according to one particularly preferred embodiment, the contact rectangles defined in each level on the outlet face of the block have centres of gravity aligned in the direction of the height h.

As already mentioned above, each burner is able to generate a flame by combustion of the fuel with the oxidizer downstream of the outlet surface of the block, the length of which may be varied at constant flame power, with the same combustion reactants (fuel and oxidizer) and without changing the total flow rates of fuel and oxidizer supplied to and injected by said burner. This enables the intensity and length of the flame to be adapted to the position of the charge with respect to the combustion assembly at several levels, each level corresponding to a level of the block and to the corresponding burner, without having to replace the corresponding burner, without having to change fuel or oxidizer and without having to modify, for this purpose, the flow rates of fuels and oxidizer supplied to and injected by the burner in question.

For clarity, it is specified that the references below to a variation in the length of a flame “at constant-power” means a variation in the length of the flame without changing the nature and the total flow rates of the combustion reactants.

Burners able to generate a flame of a length that may be varied at constant flame power are known in the prior art. For example, burners in which the flame length can be varied by modifying the flow section for at least one of the combustion reactants (fuel and/or oxidizer) are known.

It is notably known to modify the flow section mechanically, as described in EP-A-2118565, for example.

It is also known to provide, in one and the same burner, injectors with different flow sections for one and the same combustion reactant and to vary the flame length by choosing the injector and therefore also the flow section through which the burner injects the combustion reactant in question into the combustion zone.

According to a preferred embodiment, the burner able to vary flame length at constant flame power includes several injectors for one and the same combustion reactant and an adjustment system used to divide the combustion reactant to be injected into the combustion zone between said injectors. For example, when such a burner includes two oxidizer injectors, the adjustment system is used to direct the oxidizer towards the first oxidizer injector, towards the second oxidizer injector, or to divide the oxidizer between the first and second oxidizer injectors, preferably with adjustable ratios. When such a burner includes two fuel injectors, the adjustment system is used to direct the fuel towards the first fuel injector, towards the second fuel injector, or to divide the fuel between the first and second fuel injectors, preferably with adjustable ratios.

The combustion reactant injectors of the burner may usefully be coaxial injectors.

Such burners are for example described in document U.S. Pat. No. 5,743,723, the content of which is incorporated by reference into the present patent application.

Equipping such a burner with coaxial injectors having a cross section the width of which is at least twice its width and by mounting said coaxial injectors in a passage of the block shaped to fit the injectors and having an injection aperture defining a contact rectangle on the outlet face, in which the length x of the segments perpendicular to the direction of the height h is at least twice the length y of the segments parallel to the direction of the height h, enables the burner to be used as such to generate a wide flame, i.e. a flame in which the cross section has a dimension in the direction perpendicular to the direction of the height h that is wider than its dimension in the direction of the height h, and the length of which may be varied at constant flame power.

Such burners are also described in document WO-A-2010/003866, the content of which is also incorporated by reference into the present patent application. The burners described in the latter document are more particularly suitable for installation in a level in which the contact rectangle defined on the outlet face of the block has segments perpendicular to the direction of the height h of which the length x is at least twice the length y of the segments parallel to the direction of the height h, as is notably the case for the level contiguous with the lower end of the block.

It is also possible to produce such a contact rectangle defined on the outlet face of the block with segments perpendicular to the direction of the height h of length x that is at least twice the length y of the segments parallel to the direction of the height h, as is the case with the level contiguous with the lower end of the block, by means of a staged-combustion burner by staging the injection of at least one combustion reactant through the outlet face of the block in the direction perpendicular to the direction of the height h. According to such an embodiment, the burner includes, on the one hand, a semi-burner, also referred to as a “primary burner”, able to generate a partial primary combustion of the fuel with the oxidizer injected by this semi-burner, and, on the other hand, secondary injectors, for example two secondary injectors, for the combustion reactant to be staged, located on both sides of the semi-burner in the direction perpendicular to the direction of the height h, and also an adjustment system capable of adjusting the distribution of the reactant to be staged between the semi-burner and the secondary injectors. The resulting flame includes, on the one hand, a primary partial combustion zone of the combustion reactants injected by the semi-burner and one or more secondary combustion zones, in which combustion continues with the staged combustion reactant injected by the secondary injectors.

The semi-burner may for example be able to generate a primary partial combustion defining a primary combustion zone of substantially circular cross section.

The semi-burner may notably be able to vary the length of the primary combustion zone with the same fuel and the same oxidizer and at the same fuel flow rate and fuel flow rate injected by the semi-burner. Such a semi-burner may for example be a burner as described in U.S. Pat. No. 5,743,723.

One advantage of such an embodiment is that, depending on the adjustment of the distribution/staging of the one or more combustion reactants, the burner is capable both of generating a wide flame, as defined above, the length of which may be varied at constant flame power, and also a narrower flame, for example with a substantially circular cross section, but the length of which may still be varied at constant flame power.

The present invention also relates to a combustion furnace provided with at least one combustion assembly according to any one of the embodiments described above. The at least one combustion assembly according to the invention is mounted in the furnace with the lower end of the block oriented downwards, the upper end of the block oriented upwards, and the outlet face of the block oriented towards a combustion zone inside the furnace. In this way, when these burners generate a flame downstream of the outlet face of the block by combustion of the fuel with the oxidizer, the flames generated by the various burners are located in the combustion zone of the furnace.

Such a furnace advantageously includes several combustion assemblies according to the invention, with for example two such combustion assemblies positioned one opposite the other, and/or two such combustion assemblies beside one another.

The furnace may be a batch furnace, a continuous furnace or a semi-continuous furnace, also known as a semi-batch furnace.

According to a significant embodiment, the furnace is a static furnace, and therefore not a rotary furnace.

According to an advantageous embodiment, the furnace is a melting furnace.

The combustion assembly and the furnace according to the present invention are particularly suitable and useful for implementing the processes described in patent applications FR2405260 and FR2405259 from the same applicant, the teachings of which are incorporated by reference into the present application.

### BRIEF DESCRIPTION OF THE DRAWINGS

The present invention and the advantages thereof are illustrated in the non-limiting examples below, with reference to FIGS. 1 to 2, in which:

FIG. 1 is a schematic representation of a front view of a combustion assembly according to the invention, from the outlet face side,

FIG. 2 is a schematic representation of a cross section of the combustion assembly in FIG. 1 when the combustion assembly is in operation.

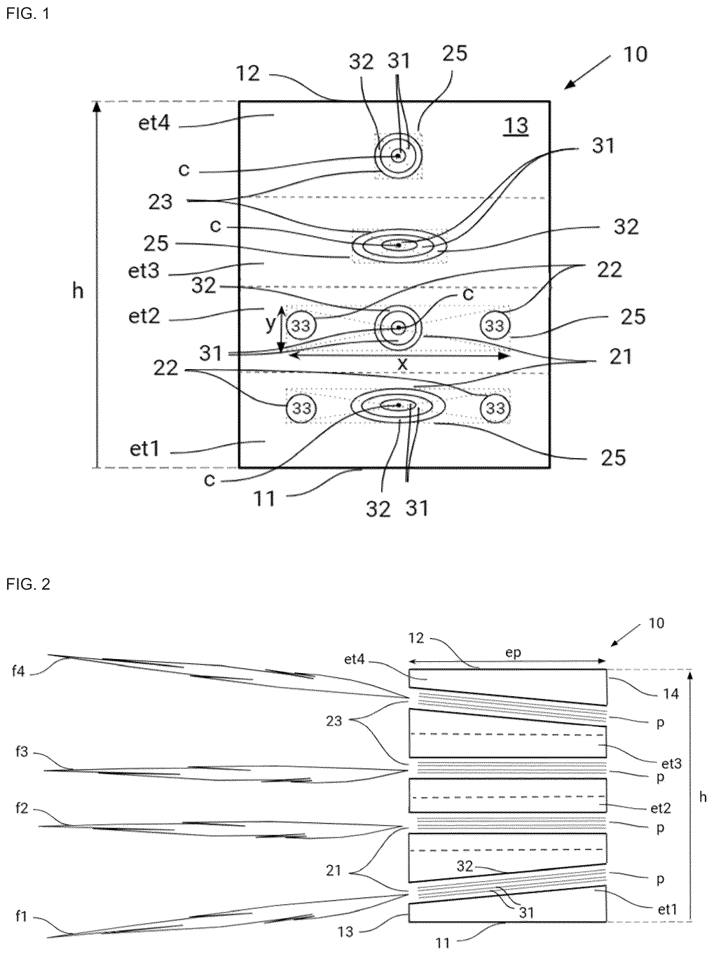

### DETAILED DESCRIPTION OF THE PREFERRED EMBODIMENTS

The combustion assembly illustrated in the figures includes a non-metallic refractory block 10 in the shape of a rectangular parallelepiped, which extends over a height h between its lower end 11 and its upper end 12.

The outlet face 13 of the block 10 is opposite the inlet face 14 of the block 10, the outlet face 13 and the inlet face 14 being spaced apart from each other by a thickness ep.

The block 10 is divided over its height h into four levels et1, et2, et3 and et4. The level et1 is contiguous with the lower end 11 and the level et4 is contiguous with the upper end 12.

Each level et1 to et4 contains one or more passages p extending from the inlet face 14 to the outlet face 13.

The levels et1 and et2 each contain three passages p and the levels et3 and et4 each contain a single passage p.

In levels et1 and et2, the passages p terminate in the outlet face 13 in a central injection aperture 21 for injecting fuel and oxidizer, flanked in the direction perpendicular to the direction of the height h by two injection apertures 22 for staged oxidizer injection.

In the levels et3 and et4, the single passage p terminates in the outlet face 13 in a single injection aperture 23 for injecting fuel and oxidizer.

A burner is mounted on each level et1, et2, et3, et4. The one or more fuel injectors 31 and the one or more oxidizer injectors 32 of the burner are inserted into the at least one passage p of the corresponding level et1, et2, et3, et4.

Each burner is capable of generating a flame f1, f2, f3, f4, the length of which may be modified at constant flame power.

The orientation of the one or more passages p of the level determines the direction in which the flame f1, f2, f3, f4 extends downstream of the outlet face 13.

The flames f1, f2, f3 and f4 are non-convergent. The flames f2 and f3 are parallel, the flames f1 and f4 are divergent with respect to one another and with respect to the other flames f2 and f3.

The burners of the levels et3 and et4 include a fuel injector 31 at the centre that is surrounded by a second fuel injector 31, which in turn is surrounded by an oxidizer injector 32. The length of the generated flame f3, f4 can be modified at constant flame power by modifying the distribution of the fuel between the two fuel injectors 31.

The burners of levels et1 and et2 are burners that allow staged combustion by staging the fuel injection. They differ from the burners of the levels et3 and et4, respectively, in that they include additional injectors 33 for the controlled staging of the injection of the oxidizer in the plane perpendicular to the direction of the height h via the two injection apertures 22 for the staged oxidizer injection.

At each level et1, et2, et3, et4, the at least one injection aperture 21, 22, 23 defines a contact rectangle 25 on the outlet face 13, of which the segments that are parallel to the direction of the height h have a length y and the segments that are perpendicular to the direction of the height h have a length x. In the illustrated embodiment, the contact rectangles defined on the outlet face 13 have centres of gravity c aligned in the direction of the height h.

In the lower level et1 and in the levels et2 and et3, the ratio between x and y is greater than 2, thereby making it possible to produce wide flames f1, f2 and f3 with a cross section in which the dimension perpendicular to the direction of the height h is greater than its dimension in the direction of the height h. When a charge is located in front of the combustion assembly, such a flame f1, f2 and f3 is used to heat the surface of the charge over a greater distance in this direction perpendicular to the height h, but over a lesser height.

In the upper level et4 of the embodiment illustrated, the ratio between x and y is substantially equal to 1. The flame f4 generated by the corresponding burner is a flame of substantially circular cross section.

The dimension x in the level et4 is smaller than the dimension x in the level et3, which in turn is smaller than the dimension x in the level et2.

Such an embodiment is particularly suitable when the combustion assembly is used to heat a charge facing the assembly and packed in a conical or frustoconical stack, the cross section of which therefore decreases towards the top. Specifically, such a configuration enables the flames f1, f2, f3, f4 to be directed only towards the charge to be heated, thus making the heating process more efficient.

The fact that the combustion assembly includes a row of burners in the direction of the height h makes it possible to adapt the heating of the charge to the height of the stack, notably by turning off or turning on the burners of the upper levels et2, et3, et4, or of the levels et3 and et4, or just the level et4, depending on the height of the stack.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A combustion assembly comprising:
a non-metallic refractory block, said block:
extending over a height h between a lower end and an upper end,
having an inlet face and an outlet face opposite the inlet face, the outlet face and the inlet face being spaced apart by a thickness ep,
the block being divided over height h into several levels, each level containing at least one passage for injecting fuel and/or oxidizer, each passage extending from the inlet face to the outlet face and terminating in at least one injection aperture in the outlet face of the block, the at least one injection aperture of each level defining, on the outlet face, a contact rectangle, two segments of which are parallel to the direction of the height h and two segments of which are perpendicular to the direction of the height h, each injection aperture of the corresponding level being located entirely inside said contact rectangle and each segment of the contact rectangle being in contact with the contour of at least one of the at least one injection apertures of the corresponding level,
several burners with one burner per level, each burner having injectors, including:
at least one injector for injecting a fuel fluidically connected to a fuel inlet of the burner; and
at least one injector for injecting an oxidizer fluidically connected to an oxidizer inlet of the burner,
each burner being mounted on the corresponding level of the block such that the fuel and oxidizer injectors of the burner are inserted into the at least one passage of said corresponding level and such that the fuel and oxidizer inlets of the burner are located on the inlet face of the block,
each burner is able to generate a flame by combustion of the fuel with the oxidizer downstream of the outlet face of the block, the length of which may be varied at constant flame power,
the at least one passage of the various levels are oriented and spaced apart such that when the burners generate a flame downstream of the outlet face of the block by combustion of the fuel with the oxidizer, the flames generated by the various burners are spaced apart from one another and non-convergent, and
the contact rectangle defined on the outlet face in the level contiguous with the lower end of the block has segments perpendicular to the direction of the height h, the length x of which is at least twice the length y of the segments parallel to the direction of the height h.

2. The combustion assembly according to claim 1, wherein the assembly has two levels and includes two burners.

3. The combustion assembly according to claim 1, wherein the at least one passage of the various levels are oriented and spaced apart such that when the burners generate a flame by combustion of the fuel with the oxidizer, at least two of the flames generated by the various burners are divergent.

4. The combustion assembly according to claim 1, wherein the contact rectangles defined on the outlet face of the block have centres of gravity aligned in the direction of the height h.

5. A combustion furnace provided with at least one combustion assembly according to claim 1, said combustion assembly being mounted in the furnace with the lower end of the block oriented downwards, the upper end of the block oriented upwards, the outlet face of the block oriented towards a combustion zone inside the furnace such that when the burners generate a flame downstream of the outlet face of the block by combustion of the fuel with the oxidizer, the flames generated by the various burners are located in the combustion zone.

6. The furnace according to claim 5, wherein the furnace is a static furnace.

7. The furnace according to claim 5, wherein the furnace is a melting furnace.
